(19) United States
(12) Patent Application Publication
(10) Pub. No.: US 2008/0072987 A1
(43) Pub. Date: Mar. 27, 2008

(54) Refrigerant transporting hose and manufacturing method therefor

(75) Inventors: Hajime Mukawa, Nagoya-city (JP); Keiichi Kitamura, Handa-city (JP); Arata Iida, Anjo-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/903,965

(22) Filed: Sep. 25, 2007

(30) Foreign Application Priority Data
Sep. 27, 2006 (JP) 2006-262562
Sep. 11, 2007 (JP) 2007-235544

(51) Int. Cl. F16L 11/08; F16L 9/14

(52) U.S. Cl. 138/126; 138/141; 977/779; 977/962; 428/36.91

(57) ABSTRACT

A refrigerant transporting hose includes a tubular gas impermeable material layer on a base layer. The gas impermeable material layer is made of a base material composed of PVOH (polyvinyl alcohol), and nano-filler particles having plate shapes. The nano-filler particles are mixed in the base material so as to enhance the barrier properties against refrigerant gas of the gas impermeable material layer. For example, a ratio of the nano-filler to the base material, contained in the gas impermeable material layer, is higher than 0% and lower than 20% by weight.

### CROSS REFERENCE TO RELATED APPLICATION

This application is based on Japanese Patent Applications No. 2006-262562 filed on Sep. 27, 2006, and No. 2007-235544 filed on Sep. 11, 2007, the contents of which are incorporated herein by reference in its entirety.

### BACKGROUND OF THE INVENTION

1. Field of the Invention

The present invention relates to a refrigerant transporting hose used in, for example, air conditioners. The refrigerant transporting hose can be suitably used for transporting refrigerant, e.g., carbon dioxide refrigerant in a refrigerant cycle.

2. Description of the Related Art

A conventional hose for transporting carbon dioxide refrigerant is described in JP-A-11-325330. This hose includes an inner tube containing a gas impermeable material layer, and this gas impermeable material layer is made of an organic material such as a saponified substance of an ethylene-vinyl acetate copolymer, a copolymer of meta-xylenediamine and adipic acid, polyvinylidene chloride, polyacrylonitrile, polyethylene-2,6-naphthalate, and the like.

When the gas impermeable material layer is made of an organic material, as mentioned above, the refrigerant transporting hose can be provided with flexibility. Furthermore, in this case, even if vibration is applied to the refrigerant transporting hose, the refrigerant transporting hose can absorb this vibration.

In the refrigerant transporting hose described in JP-A-11-325330, the leakage of refrigerant gas such as carbon dioxide is relatively suppressed. However, further reduction of the leakage of refrigerant gas is demanded from the viewpoint of the practicality of the refrigerant transporting hose constructing a refrigerator.

### SUMMARY OF THE INVENTION

In view of the foregoing problems, it is an object of the present invention to provide a refrigerant transporting hose and a manufacturing method thereof, in which the quantity of leakage of refrigerant gas can be effectively reduced even when its gas impermeable material layer is made of an organic material.

According to an aspect of the present invention, a refrigerant transporting hose includes a tubular gas impermeable material layer, and the gas impermeable material layer is made of a base material composed of PVOH (polyvinyl alcohol), and particles of nano-filler having plate shapes. The particles of the nano-filler are mixed in the base material so as to enhance barrier properties against refrigerant gas of the gas impermeable material layer. Because PVOH (polyvinyl alcohol) is used as the base material of the gas impermeable material layer and nano-filler is mixed into the base material, the quantity of leakage of refrigerant gas can be effectively reduced. For example, the nano-filler includes montmorillonite.

The particle of the nano-filler may have a thickness in a range of 0.5 to 50 nm and an aspect ratio of a particle size to the thickness in a range of 50 to 500. In this case, a ratio of the nano-filler to the base material, contained in the gas impermeable material layer, may be higher than 0% and lower than 20% by weight. More specifically, the ratio of the nano-filler to the base material, contained in the gas impermeable material layer, may be set not more than 16% or 12% by weight, or may be set not less than 2% or 4%.

The refrigerant transporting hose may have a tubular base layer made of PA (polyamide) resin. In this case, the gas impermeable material layer is formed on an outside surface or an inner surface of the tubular base layer. Furthermore, a tubular rubber layer may cover the gas impermeable material layer on its outside surface or its inside surface.

According to another aspect of the present invention, a method of manufacturing a refrigerant transporting hose having a tubular gas impermeable material layer includes a step of applying a PVOH (polyvinyl alcohol) material to one of an outside surface and an inside surface of a tubular base layer, and a step of drying the applied PVOH (polyvinyl alcohol) material to form the gas impermeable material layer on the inside surface or the outside surface of the base layer. Accordingly, it is possible to mix particles of nano-filler having plate shapes into PVOH (polyvinyl alcohol) so as to form the PVOH material, before the applying.

For example, the method of manufacturing a refrigerant transporting hose may further include a step of forming the base layer made of PA (polyamide) resin before the applying, and a step of covering an outer surface of the gas impermeable material layer with a tubular rubber layer.

### BRIEF DESCRIPTION OF THE DRAWINGS

Additional objects and advantages of the present invention will be more readily apparent from the following detailed description of preferred embodiments when taken together with the accompanying drawings. In which

FIGS. 1A and 1B are partially-omitted perspective view and cross-sectional view showing a refrigerant transporting hose according to an embodiment of the present invention;

FIG. 2 is a perspective view showing a nano-filler particle added in a gas impermeable layer;

FIG. 3 is a partially-omitted perspective view showing a refrigerant transporting hose according to another embodiment of the present invention;

FIG. 4 is a partially-omitted perspective view showing a refrigerant transporting hose according to further another embodiment of the present invention;

FIG. 5 is a partially-omitted perspective view showing a refrigerant transporting hose according to further another embodiment of the present invention;

FIG. 6 is a partially-omitted perspective view showing a refrigerant transporting hose according to further another embodiment of the present invention;

FIG. 7 is a partially-omitted perspective view showing a refrigerant transporting hose according to further another embodiment of the present invention;

FIG. 8 is a partially-omitted perspective view showing a refrigerant transporting hose according to further another embodiment of the present invention;

FIG. 9 is a partially-omitted perspective view showing a refrigerant transporting hose according to further another embodiment of the present invention; and

FIG. 10 is a graph showing a relationship between an added ratio of montmorillonite, CO₂ permeability coefficient, and distortion following property.

### DETAILED DESCRIPTION OF THE PREFERRED EMBODIMENTS

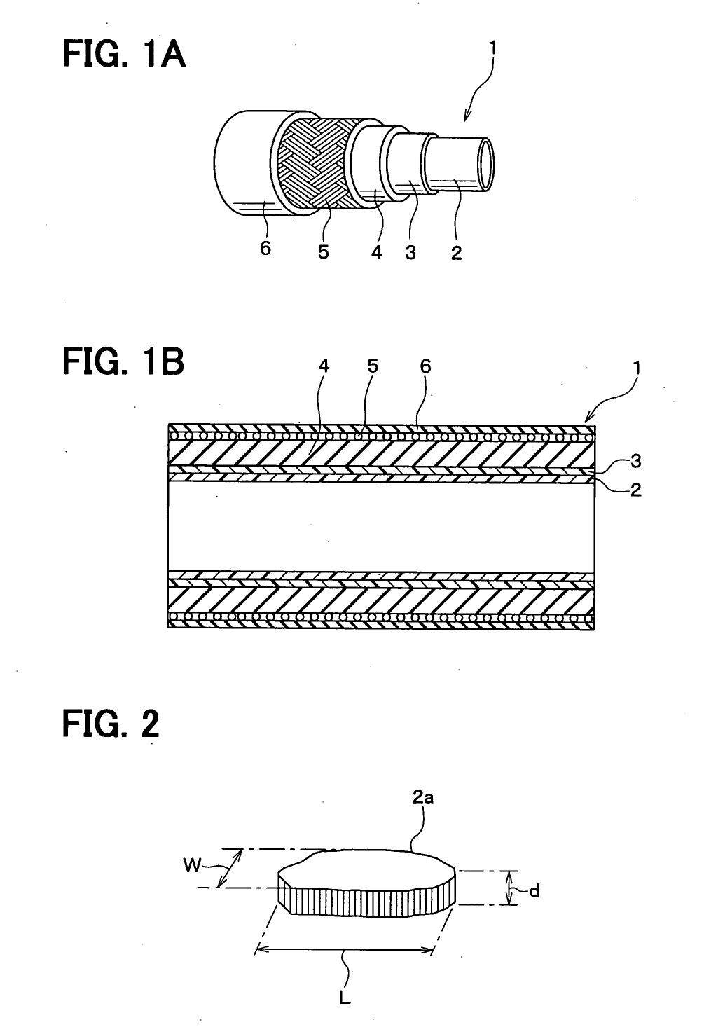

An embodiment of the present invention will be now described with reference to FIGS. 1A and 1B. FIG. 1A is a partially-omitted perspective view showing a refrigerant transporting hose according to the embodiment of the present invention, and FIG. 1B is a cross-sectional view in an axial direction showing the refrigerant transporting hose. The refrigerant transporting hose in this embodiment can be typically used for a piping system for connecting together devices in an in-vehicle air conditioner using a refrigeration cycle that uses carbon dioxide as refrigerant.

As illustrated in FIGS. 1A and 1B, the refrigerant transporting hose 1 in this embodiment is formed in the shape of cylinder that is hollow as a hole. The refrigerant transporting hole 1 is of laminated structure and five layers are provided in the following order from inside to outside: a base layer 2, a gas impermeable layer 3 as a gas impermeable material layer, an intermediate rubber layer 4, a reinforcing yarn layer 5, and an outer face rubber layer 6. These layers 2 to 6 have tubular shapes, respectively

The base layer 2 is a layer that functions as a base for constructing (supporting) the gas impermeable layer 3. When the refrigerant transporting hose 1 is manufactured, the base layer 2 functions as the base for forming a tubular layer using a gas impermeable layer material.

The base layer 2 is provided with the gas impermeable layer 3 bonded thereto. Therefore, the base layer 2 is made of a material that has affinity for bonding with the gas impermeable layer, is excellent in extrusion processability and high in resistance to swelling so that it can continuously manufactured. The base layer 2 is made of a material, such as rubber, through which refrigerant gas easily permeates. This is in order that, when refrigerant gas flowing through the refrigerant transporting hose 1 permeates the base layer, refrigerant remaining in the base layer can be caused to escape. Alternatively, the base layer 2 is made of a material, such as elastomer, resistant to permeation of refrigerant gas so that the refrigerant gas is prevented from permeating the base layer 2.

The following elastomers cited as examples can be adopted to compose the base layer 2: PA (polyamide) resins such as PA6 and PA66, and rubber materials, such as EPDM, EPM, HNBR, and NBR. The PA resins are higher in affinity for bonding to the gas impermeable layer 3, than the other organic materials. When the base layer 2 is made of PA resin, the base layer 2 and the gas impermeable layer 3 can be firmly bonded together.

The thickness of the base layer 2 is, for example, about 100 μm when PA resin is adopted, and is, for example, 0.5 mm to 10 mm when rubber material is adopted.

The gas impermeable layer 3 is a tubular layer for preventing the leakage of carbon dioxide passing through the refrigerant transporting hose 1 into the outside air. In this embodiment, the gas impermeable layer 3 is made of a material obtained by mixing nano-filler into PVOH (polyvinyl alcohol) as the base material.

The PVOH (polyvinyl alcohol) is a kind of water-soluble polymer, and can be turned into water solution or gel having a predetermined viscosity when dissolved in water. The gel described here includes not only solid gel that lost fluidity but also semisolid gel having fluidity.

The PVOH (polyvinyl alcohol) is a material low in permeability to carbon dioxide and high in barrier properties against carbon dioxide as compared with the following materials: ST811HS (PA6 prepared by DuPont, trade name: Zytel) that is used as a constituent material of a hose for transporting hydrofluorocarbon refrigerant including HFC134a; and the organic material described in JP-A-11-325330, which is incorporated herein by reference.

The following products, for example, can be used as the PVOH (polyvinyl alcohol): Gohzenol (trade name) of the Nippon Synthetic Chemical Industry Co., Ltd., Poval (trade name) of Kuraray Co., Ltd., and Denka Poval (trade name) of Denki Kagaku Kogyo Kabushiki Kaisha. As the PVOH (polyvinyl alcohol), a partly saponified product may be used or a completely saponified product may be used. Alternatively, two or more kinds of PVOH (polyvinyl alcohol) different in molecular weight or degree of saponification may be used.

FIG. 2 is a perspective view of a nano-filler particle. As illustrated in FIG. 2, the particles of the nano-filler 2a in this embodiment are in a shape that can be designated as plate shape or scale shape. In the nano-filler particle, the plate thickness d is on the nano order (nanometer level). The nano-filler 2a that meets the following conditions is used: the particle size L as the length of the principal surface in the direction of length should be, for example, on the submicron order; and the particle width W as the length of the principal surface in the direction perpendicular to the particle size L should be equal to or smaller than the particle size L and larger than the plate thickness d.

The reason why the nano-filler 2a whose particles are in plate shape is used as mentioned above is as follows: the nano-filler functions as a barrier wall against carbon dioxide that is likely to permeate the base material and brings about the consistency effect to prevent carbon dioxide from permeating and going through the base material; and the nano-filler whose particles are in plate shape is higher in the function and effect than those whose particles are in any other shape, such as needle shape and spherical shape.

The nano-filler 2a is made of material higher in barrier properties against carbon dioxide than the PVOH (polyvinyl alcohol), that is, low in carbon dioxide permeability coefficient. Examples of such material include clay, such as montmorillonite, kaolinite, halloysite, zeolite, vermiculite, and bentonite, and inorganic material, such as graphite, mica, and talc. However, the material composing the nano-filler 2a need not be such inorganic material as long as it is higher in barrier properties against carbon dioxide gas than the PVOH (polyvinyl alcohol). For example, organic material whose molecular chain is rigid and which is high in crystallinity or metal material may be adopted. In addition, the nano-filler 2a may be composed of a single one of the above materials or may be composed of a mixture or a compound of this single substance and any other substance.

The barrier properties against carbon dioxide gas tend to be enhanced with reduction in the particle size L of the nano-filler 2a. It has been found that, when substances obtained by adding nano-filler made of various inorganic materials to the base material are compared with one another for barrier properties, the substance obtained by adding nano-filler made of montmorillonite is higher in barrier properties against carbon dioxide than others. Therefore, one of the materials favorable for the nano-filler 2a is montmorillonite.

The thickness of the gas impermeable layer 3 is, for example, 5 to 20 μm (center value: about 10 μm).

The intermediate rubber layer 4 prevents the permeation of moisture from the outside air. When the PVOH (polyvinyl alcohol) absorbs moisture, it is modified and is degraded in barrier properties against refrigerant gas, for example, carbon dioxide. To suppress this degradation in barrier properties, it is desirable to use resin or rubber that is low in the permeation of moisture from the outside air to compose the intermediate rubber layer 4.

The reinforcing yarn layer 5 is provided to maintain the strength of the hose against refrigerant gas, for example, carbon dioxide, whose pressure becomes very high in operation, and to maintain the shape of the hose to prevent deformation under pressure. Examples of materials excellent in resistance to pressure, used for the reinforcing yarn layer 5, include organic fibers, such as aramid and polyethylene terephthalate (PET). A single layer or multiple layers of what is obtained by braiding these fibers are used as the material of the reinforcing yarn layer.

The outer face rubber layer 6 is provided outside of the reinforcing yarn layer 5 in order to prevent damage to and raveling of the reinforcing yarn layer 5 due to contact or the like, and in order to enhance the resistance to environment of the refrigerant transporting hose 1 required in the place of installation, including weather resistance, heat resistance, liquid resistance (oil resistance), and the like. The moisture absorption of the PVOH (polyvinyl alcohol) due to the ingress of moisture from the outside air may also be prevented by the outer face rubber layer 6.

For the material for forming the outer face rubber layer 6, those that meet the above purposes and do not impair the flexibility of the entire hose are desirable. Possible examples of such material include ethylene-propylene rubber, chloroprene rubber, butyl rubber, acrylonitrile butadiene rubber, and the like.

Description will be given to a manufacturing method for the refrigerant transporting hose 1 of the above-mentioned structure.

To implement a continuous manufacturing process at low cost, the tubular base layer 2 is formed around a resin or metal tube designated as mandrel by extrusion molding using resin. Subsequently, a PVOH (polyvinyl alcohol) layer mixed with nano-filler is formed on the outer circumferential surface of the base layer 2, and the gas impermeable layer 3 is thereby formed.

One of methods that may be adopted to shape the PVOH (polyvinyl alcohol) layer mixed with nano-filler is such that: the PVOH (polyvinyl alcohol) prepared so that it can be applied, for example, a water solution obtained by dissolving the PVOH (polyvinyl alcohol) in water is prepared; nano-filler is mixed with it and then the water solution is applied to the outer circumferential surface of the base layer 2. Then, the work piece is dried. For the viewpoint of the enhancement of yield and working efficiency, it is desirable to adjust the concentration and viscosity of the water solution. That is, while this method is carried out, the water solution is provided with such consistency that, when the water solution of the PVOH (polyvinyl alcohol) mixed with the nano-filler is applied, the water solution does not droop from the base layer 2, and the gas impermeable layer 3 of a desired thickness can be formed by one time of application.

Gelatinous PVOH (polyvinyl alcohol) may be used in place of the water solution of the PVOH (polyvinyl alcohol). When the gelatinous PVOH (polyvinyl alcohol) is used in such a state that it has fluidity, it can be applied; thereby, it can be handled as the water solution is. However, when PVOH (polyvinyl alcohol) is in such a state that it does not have fluidity, the material of PVOH (polyvinyl alcohol) is collapsed into multiple particles by kneading or the like to provide it with fluidity so that it can be applied.

After PVOH (polyvinyl alcohol) is applied, it is dried. In this example, water is adopted as solvent for dissolving or gelating PVOH (polyvinyl alcohol). Any other solvent can be adopted as long as the following can be implemented: PVOH (polyvinyl alcohol) can be provided with fluidity and can be brought into such a state that it can be applied by adding the solvent; and a PVOH (polyvinyl alcohol) layer can be formed by drying it.

Subsequently, the intermediate rubber layer 4 is formed outside the gas impermeable layer 3 by extrusion molding, and then reinforcing threads are braided to form the reinforcing yarn layer 5 outside the intermediate rubber layer 4. The outer face rubber layer 6 is formed outside the reinforcing yarn layer 5 by extrusion molding, and the thus obtained tubular integrated body is cured to obtain the refrigerant transporting hose 1.

In this embodiment, as mentioned above, a multi-layer refrigerant transporting hose is manufactured such that: PVOH (polyvinyl alcohol) is applied to the base layer 2, or one of the two layers of the base layer 2 and the intermediate rubber layer 4 that are positioned inside and outside; this PVOH (polyvinyl alcohol) is dried to form a PVOH layer; thereafter, the intermediate rubber layer 4 is provided outside the PVOH layer. As a result, the gas impermeable material layer 3 is formed between two layers positioned inside and outside in the multilayer refrigerant transporting hose.

The PVOH (polyvinyl alcohol) can be applied to either or both of the two layers positioned inside and outside. For example, the PVOH (polyvinyl alcohol) may be applied to the inner circumferential surface of the outer one of the two layers positioned inside and outside. When there are provided an inner layer positioned inside, an outer layer positioned outside and an intermediate layer positioned between them, the PVOH (polyvinyl alcohol) may be applied to the outer circumferential surface of the inner layer and the outer circumferential surface of the intermediate layer so that PVOH (polyvinyl alcohol) is positioned between any two of the three layers.

According to this embodiment, as mentioned above, the PVOH (polyvinyl alcohol) is used as the base material for forming the gas impermeable layer 3. Therefore, the quantity of leakage of carbon dioxide can be reduced as compared with cases where the material described in JP-A-11-325330 is used to form the gas impermeable layer 3. Further, since the nano-filler is mixed into the base material, the quantity of leakage of carbon dioxide can be reduced as compared with cases where the nano-filler is not mixed.

According to the refrigerant transporting hose 1 in this embodiment, degradation in vibration damping efficiency can be prevented by reducing the thicknesses of the base layer 2 and the gas impermeable layer 3 even when the elasticity coefficient is increased as compared with ST811HS (PA prepared by DuPont, trade name: Zytel) that is used as a constituent material of a hose for transporting hydrofluorocarbon refrigerant including HFC134a.

In the conventional in-vehicle air conditioners using carbon dioxide as refrigerant, hoses whose impermeable layer is generally metal are used, thereby reducing flexibility. Use of the refrigerant transporting hose 1 in this embodiment makes it possible to provide flexibility required for tubular members unlike metal hoses, and it is possible to reduce the weight and cost of the refrigerant transporting hose 1.

### Other Embodiments

Although the present invention has been fully described in connection with the preferred embodiment thereof with reference to the accompanying drawings, it is to be noted that various changes and modifications will become apparent to those skilled in the art.

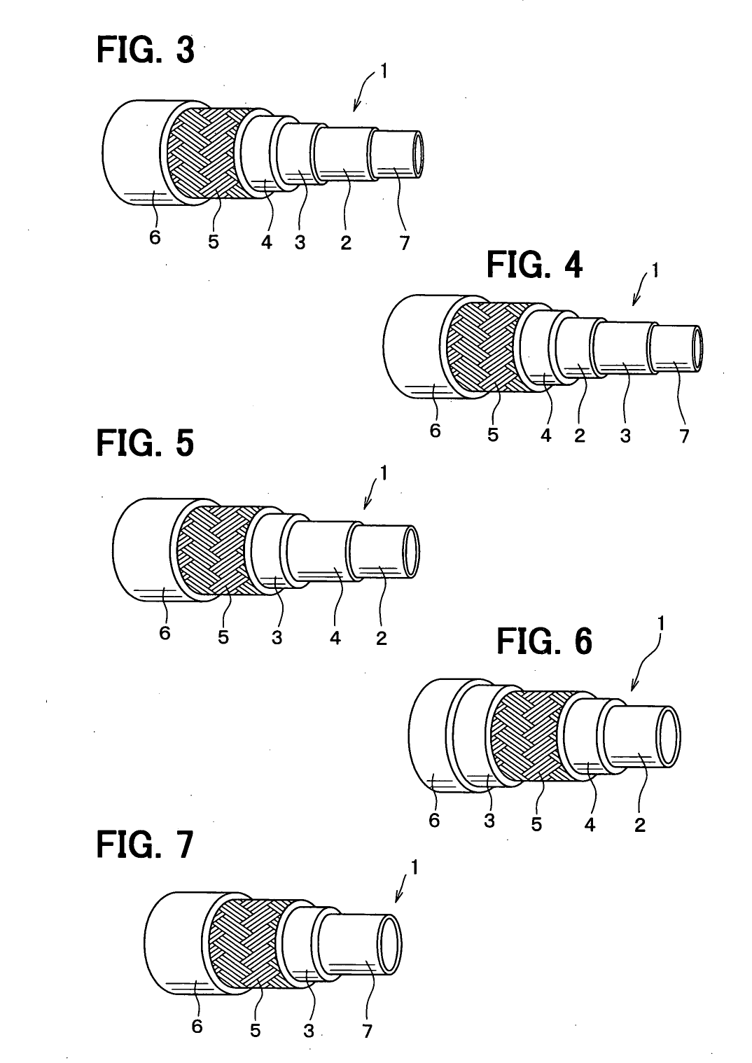

(1) For example, the configuration of the refrigerant transporting hose 1 is not limited to that of the refrigerant transporting hose 1 described as the first embodiment with reference to FIGS. 1A and 1B. As illustrated in FIG. 3 to FIG. 9, the configuration of the refrigerant transporting hose 1 illustrated in FIGS. 1A and 1B may be modified by taking the following measures: changing the order of lamination of the layers; omitting any layer other than the gas impermeable layer 3; or adding a new separate layer, etc.

FIG. 3 to FIG. 9 respectively illustrate examples of the configuration of the refrigerant transporting hose 1. In FIG. 3 to FIG. 9, the same constructional elements as in FIG. 1A will be marked with the same reference numerals.

The refrigerant transporting hose 1 illustrated in FIG. 3 is different from the refrigerant transporting hose 1 illustrated in FIG. 1A in that an inner face rubber layer 7 is provided inside of the base layer 2. The inner face rubber layer 7 is made of, for example, the same material as that of the intermediate rubber layer 4.

The refrigerant transporting hose 1 illustrated in FIG. 4 is obtained by modifying the refrigerant transporting hose 1 illustrated in FIG. 3 such that the positions of the base layer 2 and the gas impermeable layer 3 are changed to dispose the gas impermeable layer 3 inside of the base layer 2. This refrigerant transporting hose 1 is manufactured by a method obtained by changing the manufacturing method described with respect to the first embodiment such that, PVOH (polyvinyl alcohol) mixed with nano-filler is applied to the outer circumferential surface of the inner face rubber layer 7 in place of the base layer 2, and it is dried.

The refrigerant transporting hose 1 illustrated in FIG. 5 is different from the refrigerant transporting hose 1 illustrated in FIGS. 1A and 1B in that: the positions of the gas impermeable layer 3 and the intermediate rubber layer 4 are changed, and the gas impermeable layer 3 is disposed between the intermediate rubber layer 4 and the reinforcing yarn layer 5. This refrigerant transporting hose 1 is manufactured by a method obtained by changing the manufacturing method described with respect to the first embodiment such that: for example, PVOH (polyvinyl alcohol) mixed with nano-filler is applied to the outer circumferential surface of the intermediate rubber layer 4 in place of the base layer 2, and it is dried.

The refrigerant transporting hose 1 illustrated in FIG. 6 is different from the refrigerant transporting hose 1 illustrated in FIGS. 1A and 1B in that: the position of the gas impermeable layer 3 is changed, and it is disposed between the reinforcing yarn layer 5 and the outer face rubber layer 6. In the refrigerant transporting hoses 1 illustrated in FIGS. 5 and 6, the moisture absorption of PVOH (polyvinyl alcohol) due to the permeation of moisture from the outside air is prevented by the outer face rubber layer 6. In the refrigerant transporting hose 1 illustrated in FIG. 6, the gas impermeable layer 3 is formed by, for example, applying PVOH (polyvinyl alcohol) mixed with nano-filler to the outer circumferential surface of the reinforcing yarn layer 5 and drying it.

The refrigerant transporting hose 1 illustrated in FIG. 7 is obtained by modifying the refrigerant transporting hose 1 illustrated in FIG. 1A such that: the base layer 2 and the intermediate rubber layer 4 are omitted and the position of the gas impermeable layer 3 is relatively changed. The inner face rubber layer 7, the gas impermeable layer 3, the reinforcing yarn layer 5, and the outer face rubber layer 6 are positioned in this order from inside of the tube shape in the embodiment of FIG. 7. In this case, the gas impermeable layer 3 is formed by, for example, applying PVOH (polyvinyl alcohol) mixed with nano-filler to the outer circumferential surface of the inner face rubber layer 7, and drying it.

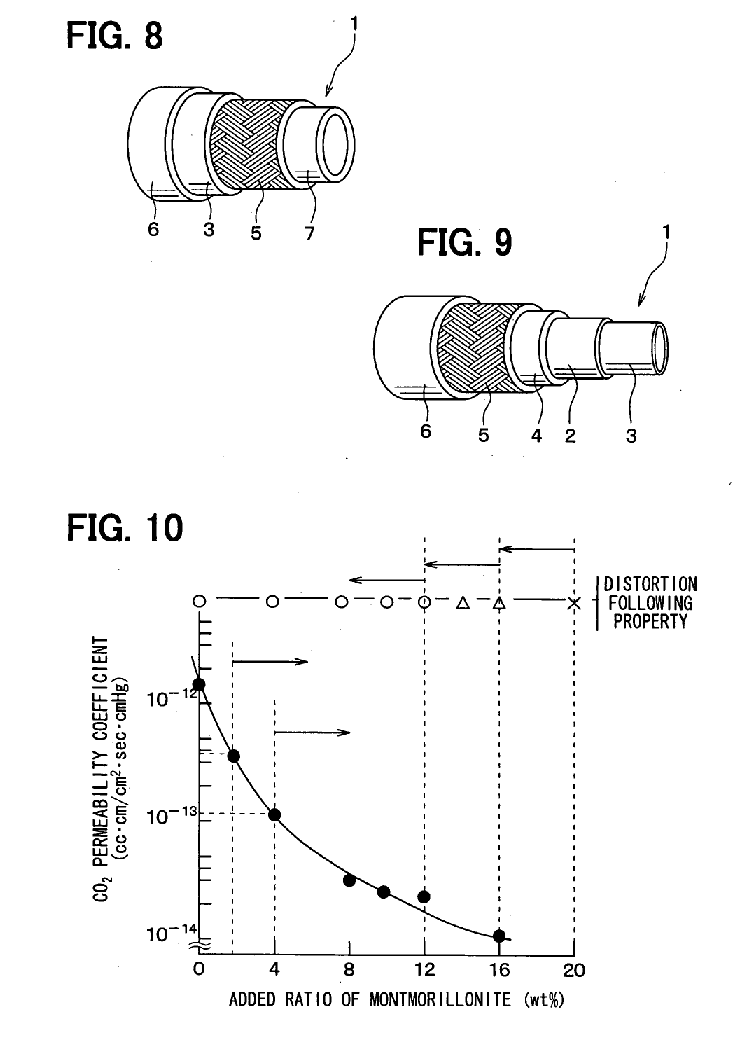

The refrigerant transporting hose 1 illustrated in FIG. 8 is obtained by modifying the refrigerant transporting hose 1 illustrated in FIG. 1A such that: the base layer 2 and the intermediate rubber layer 4 are omitted; and the position of the gas impermeable layer 3 is changed and it is disposed between the reinforcing yarn layer 5 and the outer face rubber layer 6. The inner face rubber layer 7, reinforcing yarn layer 5, gas impermeable layer 3, and outer face rubber layer 6 are positioned in this order from inside. In this case, the gas impermeable layer 3 is formed by applying PVOH (polyvinyl alcohol) to the outer circumferential surface of the reinforcing yarn layer 5 and drying it.

The refrigerant transporting hose 1 illustrated in FIG. 9 is obtained by modifying the refrigerant transporting hose 1 illustrated in FIGS. 1A and 1B such that: the positions of the base layer 2 and the gas impermeable layer 3 are changed, and the gas impermeable layer 3 is disposed inside the base layer 2. In the description of the above embodiments of FIGS. 1A, 3 to 8, the cases where the gas impermeable layer 3 obtained by mixing nano-filler into PVOH (polyvinyl alcohol) is formed on the outer circumferential surface of the base layer 2 or the other member (4, 5, 7) are taken as examples. Instead, the gas impermeable layer 3 may be formed by applying PVOH (polyvinyl alcohol) mixed with nano-filler to the inner circumferential surface of the base layer 2 and drying it.

When the gas impermeable layer 5 is formed as mentioned above, the refrigerant transporting hose 1 illustrated in FIG. 9 may be modified as follows: the base layer 2 is omitted and the gas impermeable layer 3 obtained by mixing nano-filler into PVOH (polyvinyl alcohol) is formed on the inner circumferential surface of the intermediate rubber layer 4. Or, the refrigerant transporting hose 1 illustrated in FIG. 6 may be modified as follows: the base layer 2 is made of rubber and the intermediate rubber layer 4 is omitted.

(2) In the description of the above embodiments, refrigerant transporting hoses utilized in a refrigeration cycle using carbon dioxide as refrigerant are taken as examples. However, the refrigerant transporting hose of the invention can also be used as a refrigerant transporting hose used in a refrigeration cycle using any other refrigerant. Such refrigerant includes hydrofluorocarbon refrigerant including HFC134a, hydrocarbon refrigerant including butane, natural refrigerant such as ammonia, and the like. Even when hydrofluorocarbon refrigerant including HFC134a is transported, for example, the barrier properties against the refrigerant gas are higher than those of conventional refrigerant transporting hoses as with carbon dioxide.

(3) In the above-mentioned embodiments, the gas impermeable layer 3 is made of a material obtained by mixing nano-filler into PVOH (polyvinyl alcohol) as the base material. Instead, the gas impermeable layer 3 may be made of a material containing only PVOH (polyvinyl alcohol). The manufacturing method for the refrigerant transporting hose in this case is the same as those in the above embodiments except that nano-filler is omitted.

### Examples

Hereafter, description will be given to examples and comparative examples with respect to the material composing the gas impermeable layer 3.

A film-like sample was prepared by using commercially available PVOH (polyvinyl alcohol) as the base material and commercially available montmorillonite as the nano-filler and mixing them. The montmorillonite used is a filler whose particles are in the shape of plate, 0.5 to 50 nm in plate thickness d and 50 to 500 in the ratio of particle size L to plate thickness d. Here, the ratio of particle size L to plate thickness d is an aspect ratio L/d (Refer to FIG. 2.)

The various samples were measured and tested for carbon dioxide permeability coefficient and distortion following properties. That is, samples different in the ratio of montmorillonite added to PVOH (polyvinyl alcohol) and samples as comparative examples composed only of PVOH (polyvinyl alcohol) with no montmorillonite added were prepared. FIG. 10 illustrates the results of the measurement and testing.

The carbon dioxide permeability coefficient illustrated in FIG. 10 indicates results obtained by carrying out measurement in accordance with “JIS K 7126: Testing Method for Gas Transmission Rate Through Plastic Films and Sheetings.” The results of the distortion following property testing illustrated in FIG. 10 were obtained by elongating film-like samples by 5% in the direction of length at room temperature and observing the state of the samples to determine the presence or absence of cracking or the like. The cross (x) in the drawing indicates that cracking took place; the triangles (Δ) in the drawing indicate that there was no occurrence of cracking but changes such as wrinkling and whitening came out; and the open circles (◯) in the drawing indicate that no change came out.

The reason why the samples were elongated by 5% in distortion following property testing is as follows: when a refrigerant transporting hose is bent, tensile stress is exerted on part of the hose, and the resulting elongation of the refrigerant transporting hose, converted from the normal status of use of the refrigerant transporting hose, is 5% or so at the maximum.

With respect to the carbon dioxide permeability coefficient, as shown in FIG. 10, the carbon dioxide permeability coefficient is lowered as the ratio of added montmorillonite (ratio to the base material by weight) is increased from 0% to 2 to 4 to 8 to 10 to 12 to 16 wt %.

When the ratio of added montmorillonite is 0 wt %, 2 wt %, and 4 wt %, the carbon dioxide permeability coefficient is respectively 1.2×0⁻¹², 4×10⁻¹³, and 2×10⁻¹³ (cc·cm/cm²·sec·cm Hg). The ratio of enhancement of the quantity of leakage of carbon dioxide suppressed by PVOH (polyvinyl alcohol) by adding montmorillonite is approximately ⅓ when the ratio of addition is 2 wt %, and is approximately ⅙ when it is 4 wt %.

As a result, when the refrigerant holding performance required from a refrigerant transporting hose is relatively low, it is desirable to set the ratio of added montmorillonite to 2 wt % or higher. An example of such an occasion is when it is required that a refrigeration cycle can be operated for five years without replenishing refrigerant.

When the refrigerant holding performance required from a refrigerant transporting hose is relatively high, it is desirable to set the ratio of added montmorillonite to 4 wt %. Examples of such an occasion include when it is required that a refrigeration cycle can be operated for 15 years without replenishing refrigerant and when it is required to control the quantity of leakage of carbon dioxide per year to 1 g or less.

With respect to distortion following properties, as shown in FIG. 10, when the ratio of addition was 12 wt % or below, no change came out in samples and the distortion following properties were favorable; when the ratio of addition was 14 or 16 wt %, changes such as wrinkling and whitening were observed; and when the ratio of addition was 20 wt %, cracking occurred in samples and distortion following properties were inferior. As mentioned above, it can be said that increase in additive amount rigidifies the gas impermeable layer 3 and increases the elasticity of a hose, thereby degrading the properties of following distortion.

Therefore, in order to prevent breakage in the gas impermeable layer 3 even if distortion occurs in a refrigerant transporting hose and in order to make it possible to follow the distortion, it is desirable to set the ratio of added montmorillonite to a value less than 20 wt % or not more than 16 wt % with which cracking does not occur, and is preferably to set a value not more than 12 wt % with which wrinkling does not occur. The reason why a value not more than 12 wt % is preferable is as follows: when high-temperature, high-pressure refrigerant is transported, there is a possibility that breakage occurs in an area where the strength is degraded due to the occurrence of wrinkling or the like.

Such changes and modifications are to be understood as being within the scope of the present invention as defined by the appended claims.

What is claimed is:

1. A refrigerant transporting hose comprising:
a tubular gas impermeable material layer,
wherein the gas impermeable material layer is made of a base material composed of PVOH (polyvinyl alcohol), and particles of nano-filler having plate shapes which are mixed in the base material so as to enhance barrier properties against refrigerant gas of the gas impermeable material layer.

2. The refrigerant transporting hose as in claim 1,
wherein the nano-filler includes montmorillonite.

3. The refrigerant transporting hose as in claim 1,
wherein the particle of the nano-filler has a thickness in a range of 0.5 to 50 nm and an aspect ratio of a particle size to the thickness in a range of 50 to 500.

4. The refrigerant transporting hose as in claim 3,
wherein a ratio of the nano-filler to the base material, contained in the gas impermeable material layer, is higher than 0% and lower than 20% by weight.

5. The refrigerant transporting hose as in claim 4,
wherein the ratio of the nano-filler to the base material, contained in the gas impermeable material layer, is not more than 12% by weight.

6. The refrigerant transporting hose as in claim 4,
wherein the ratio of the nano-filler to the base material, contained in the gas impermeable material layer, is not less than 2%.

7. The refrigerant transporting hose as in claim 4,
wherein the ratio of the nano-filler to the base material, contained in the gas impermeable material layer, is not less than 4%.

8. The refrigerant transporting hose as in claim 1, further comprising
a tubular base layer made of PA (polyamide) resin,
wherein the gas impermeable material layer is formed on an outside surface of the tubular base layer.

9. The refrigerant transporting hose as in claim 1, further comprising
a tubular rubber layer,
wherein the gas impermeable material layer has an outside surface covered with the tubular rubber layer.

10. A method of manufacturing a refrigerant transporting hose including a tubular gas impermeable material layer, comprising:
applying a PVOH (polyvinyl alcohol) material to one of an outside surface and an inside surface of a tubular base layer; and
drying the applied PVOH (polyvinyl alcohol) material to form the gas impermeable material layer on the inside surface or the outside surface of the base layer.

11. The method of manufacturing a refrigerant transporting hose as in claim 10, further comprising
mixing particles of nano-filler having plate shapes into PVOH (polyvinyl alcohol) to form the PVOH material, before the applying.

12. The method of manufacturing a refrigerant transporting hose as in claim 10, further comprising:
forming the base layer made of PA (polyamide) resin, wherein the PVOH (polyvinyl alcohol) material is applied to the outer surface of the base layer after the forming of the base layer, so as to form the gas impermeable material layer on the outer surface of the base layer; and
covering an outer surface of the gas impermeable material layer with a tubular rubber layer.

13. The method of manufacturing a refrigerant transporting hose as in claim 11,
wherein the particles of the nano-filler are mixed to PVOH (polyvinyl alcohol) to form the PVOH material in the mixing such that a ratio of the nano-filler to the PVOH (polyvinyl alcohol) is higher than 0% and lower than 20% by weight.

14. The method of manufacturing a refrigerant transporting hose as in claim 11,
wherein the particles of the nano-filler are mixed to PVOH (polyvinyl alcohol) to form the PVOH material in the mixing such that a ratio of the nano-filler to the PVOH (polyvinyl alcohol) is not more than 12% by weight.

15. The method of manufacturing a refrigerant transporting hose as in claim 11,
wherein the particles of the nano-filler are mixed to PVOH (polyvinyl alcohol) to form the PVOH material in the mixing such that a ratio of the nano-filler to the PVOH (polyvinyl alcohol) is not less than 2% by weight.

16. The method of manufacturing a refrigerant transporting hose as in claim 11,
wherein the particles of the nano-filler are mixed to PVOH (polyvinyl alcohol) to form the PVOH material in the mixing such that a ratio of the nano-filler to the PVOH (polyvinyl alcohol) is not less than 4% by weight.
